(19) United States
(12) Patent Application Publication
(10) Pub. No.: US 2004/0095360 A1
(43) Pub. Date: May 20, 2004

(54) User interface of an image capturing apparatus and an image processing method thereof

(76) Inventors: Wen-Chao Tseng, Taichung (TW); Chin-Lien Chang, Hsin-Chu City (TW); Kuo-Jeng Wang, Kaohsiung City (TW)

Correspondence Address: NATH & ASSOCIATES, 1030 15th STREET, 6TH FLOOR, WASHINGTON, DC, 20005, US

(21) Appl. No.: 10/426,872

(22) Filed: May 1, 2003

(30) Foreign Application Priority Data
Nov. 15, 2002 (TW) 091133671

(51) Int. Cl. G09G 5/00

(52) U.S. Cl. 345/619

(57) ABSTRACT

A user interface of an image capturing apparatus and an image processing method thereof are provided. The user interface of the present invention includes an image preview window, a first region for displaying image analysis results and a second region for displaying function buttons. The image preview window is used for displaying at least one preview image and serving for a user to select at least one preview image to perform a normal scan. The first region for displaying image analysis results is used for displaying an image analysis result under a normal scan for the selected preview image. The second region includes a plurality of function buttons for a user to select and execute desired functions.

### BACKGROUND OF THE INVENTION

1. Field of the Invention

The present invention relates to a user interface, and more particularly to a user interface utilized in an image capturing apparatus.

2. Description of the Prior Art

Over the past decade, there has been an increased need and demand for analysis of various biological specimens, for purposes ranging from pregnancy testing to drug analysis. Considerable time and effort has been expended by way of devising systems and analytic techniques to ensure reliable testing and accurate results.

Moreover, with increasing rise in the use of abuse-type drugs, the need for detecting and identifying those drugs and their metabolites is becoming more important. With this need, many more tests are required to monitor the use of abuse-type drugs.

Thin layer chromatography (TLC) screening procedures for detecting drugs in urine require the careful preparation of a test specimen and then a skillful application of that test specimen to a plate placed into a developing chamber. Once the plate is removed from the chamber and dried, it is sprayed with visualization reagents. Location and color of spots are compared with those of known standards. Qualitative judgements are made as to the presence of various drugs in the unknown sample. The procedure is tedious, time consuming and requires skilled personnel to interpret the results.

The EMIT (Enzyme Multiplied Immuno-chemical Test) procedure is a semi-quantitative immuno-assay for drugs of abuse in biological fluids. The laboratory test requires trained technicians to perform and the equipment necessarily costs several thousands of dollars.

The RIA (Radio-Immuno-Assay) procedure is a sensitive and quantitative laboratory procedure for detecting drugs of abuse. The various immunochemicals are labeled with radioactive compounds and require special care in their use and disposal. A license is required from the government to use this laboratory procedure because of the presence of radioactive materials. The GLC (Gas-Liquid Chromatography) procedure can provide the highest degree of accuracy in drug analysis. However, the necessary equipment is expensive and the procedure is complicated. Consequently, highly trained personnel are required for its use.

Each of these well-known procedures requires skilled technicians and relatively sophisticated equipment. Consequently, the testing procedure is necessarily expensive.

However, the increase of drug abuse has increased a need for new methods of analyzing drug residues in physiological fluid. A drug abuse test paper for testing the presence or absence of drugs in a fluid specimen collected from a test subject is developed. The drug abuse test paper is prepared in accordance with unique procedure whereby pH insensitivity and color change sensitivities to tested fluids are obtained. The color change of the drug abuse test paper sensitive to one specific substance present in the fluid specimen collected from the test subject applied on the drug abuse test paper is simply verified by visual judgement. This abuse-type drug testing is rapid and convenient. However, it is not convincing for concluding the test subject has used abuse-type drugs.

Accordingly, it is an intention to provide means capable of detecting and identifying the presence or absence of drugs of abuse in a fluid specimen, which can overcome the problems of the conventional methods.

### SUMMARY OF THE INVENTION

It is one objective of the present invention to provide a user interface of an image capturing apparatus, in which the user interface provides various function buttons for a user capable of easily and conveniently performing functions of selecting preview images, normal scan, printing out images and image analysis results thereof.

It is another objective of the present invention to provide a user interface of an image capturing apparatus, which can be used to capture an image of a test strip having a color pattern occurring due to contacting with a tested solution, and the user interface provides various functions for analyzing the image, displaying and print out the image and the image analysis result thereof.

It is still another objective of the present invention to provide a user interface of an image capturing apparatus, which can be used to qualitatively and quantitatively monitor color responses of an abuse-type drug test paper having tested a biological specimen collected from a subject to improve accuracy of the drug of abuse detection.

It is a further objective of the present invention to provide a method for analyzing an image of a color pattern of a test strip, which can determine a color response of a target line of the color pattern based on the image of the color pattern, and thereby determining whether the target line has a positive response or a negative response in response to a tested solution so as to detect whether a specific component to be detected is present in the tested solution or not.

In order to achieve the above objectives of this invention, the present invention provides a user interface of an image capturing apparatus. The user interface includes an image preview window, a first region for displaying image analysis results and a second region for displaying function buttons. The image preview window is used for displaying at least one preview image and serving for a user to select at least one preview image to perform a normal scan. The first region for displaying image analysis results is non-overlapped with the image preview window, and used for displaying an image analysis result under the normal scan for at least the selected preview image. The second region for displaying function buttons is non-overlapped with the image preview window and the first region for displaying image analysis results. The second region includes a plurality of function buttons for a user to select and execute desired functions.

The user interface of the present invention can be associated with a scanner. A user can directly click function buttons displayed on the user interface to execute image preview, selection of preview images, normal scan, switch of displaying of various images under the normal scan and the image analysis results thereof and print out of the images and the images analysis results thereof. The image capturing apparatus associated with the user interface can be used to capture an image of a test strip having a color pattern occurring due to a tested solution, then analyzing the image and displaying/printing out the image analysis result of the test strip. Specific components in the tested solution can be detected and identified in accordance with the image analysis result. Therefore, the image capturing apparatus associated with the user interface can be utilized in the detection of drug of abuse to capture an image of an abuse-type drug test paper contacting with a biological specimen collected from a subject to monitor whether drugs of abuse present in the biological specimen.

### BRIEF DESCRIPTION OF THE DRAWINGS

The objectives and features of the present invention as well as advantages thereof will become apparent from the following detailed description, considered in conjunction with the accompanying drawings.

FIG. 1 is a schematic top view of a holder of the present invention;

FIG. 2 is a schematic view of an image of a scanning object of the present invention;

FIG. 3A is a schematic configuration of a user interface according to a preferred embodiment of the present invention;

FIG. 3B is a schematic view of preview images displayed on an image preview window of the user interface of FIG. 3A;

FIG. 4 shows an image analysis result printed out by clicking a print result button of the user interface of FIG. 3A;

FIG. 5 shows an image and the image analysis result thereof printed out by clicking a print report button of the user interface of FIG. 3A;

FIG. 6 is a schematic top view of a test strip having a color pattern; and

FIG. 7 is a diagram of image intensity versus image position of the color pattern of the test strip of FIG. 6.

### DESCRIPTION OF THE PREFERRED EMBODIMENT

The present invention provides a user interface of an image capturing apparatus and an image processing method thereof. The user interface of the present invention includes an image preview window, a first region for displaying image analysis results and a second region for displaying function buttons. The image preview window is used for displaying at least one preview image and serving for a user to select at least one preview image to perform a normal scan. The first region for displaying image analysis results is used for displaying an image analysis result under a normal scan for the selected preview image. The function buttons displayed in the second region includes a preview button, a scan button, an auto button, a print result button, a print report button and an auto print button. The preview button provides an image preview scan function, and the scan button provides a normal scan function for the selected preview image. The auto button provides a normal scan function for the whole page of preview images displayed on the preview window. The print result button provides a function for printing out the image analysis result under the normal scan for the selected preview image. The print report button provides a function for printing out an image under the normal scan for the selected preview image and the image analysis result thereof. The auto print button provides a function for print out images under the normal scan for the whole page of preview images displayed on the preview window and the image analysis results thereof.

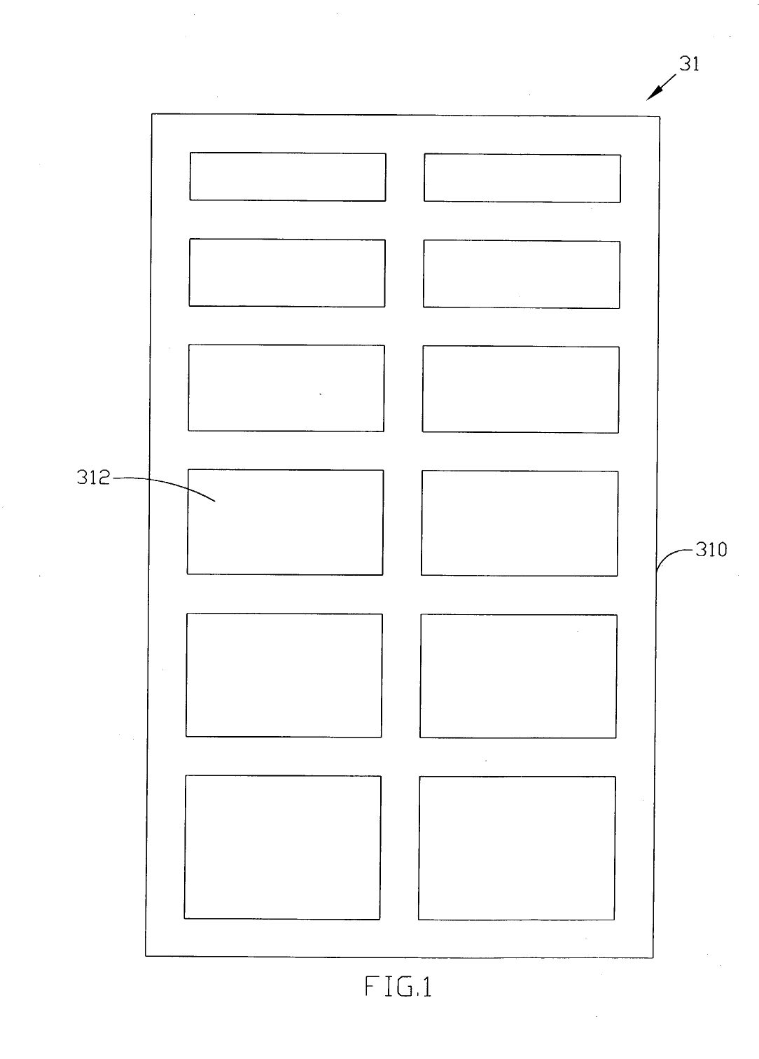

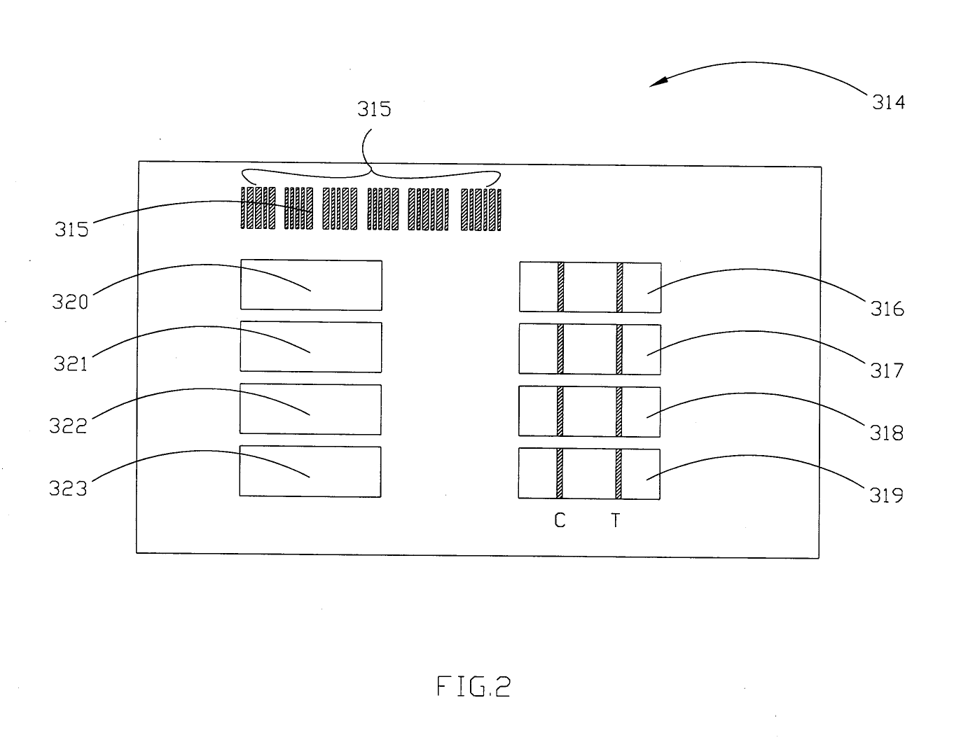

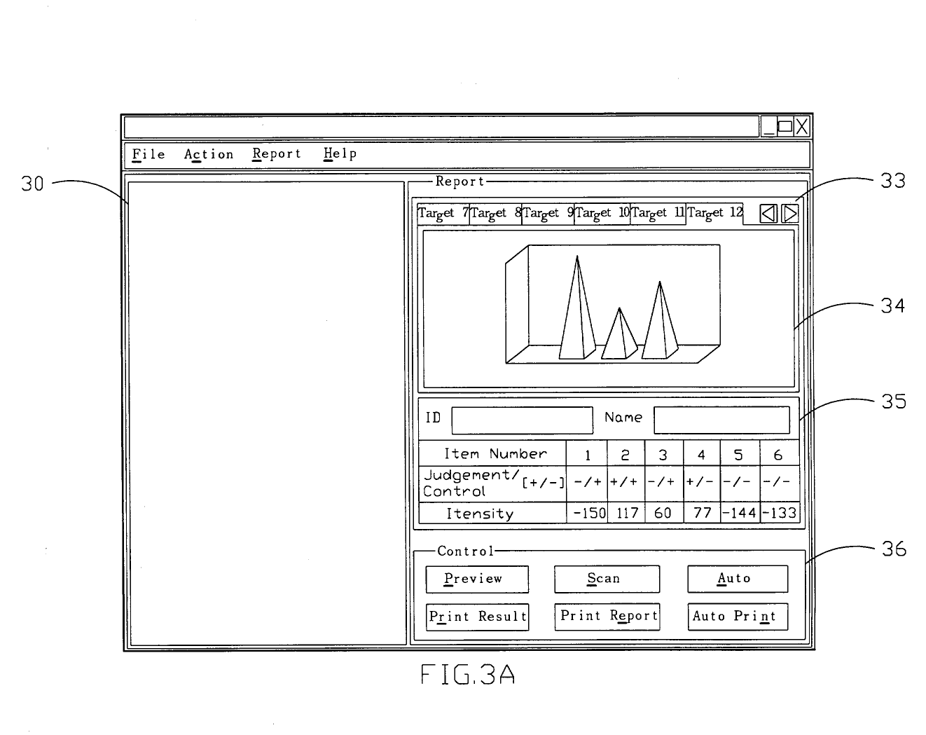

FIG. 3A is a schematic configuration of a user interface according to a preferred embodiment. An image preview window 30 is displayed on a right side portion of the user interface. Referring to FIG. 3B, which shows a schematic view of the image preview window 30. The image preview window 30 displays a preview image of a rectangular-shaped holder 31 and twelve scanning objects placed therein. As shown in FIG. 1, the holder 31 includes an outer frame 310 having a heavy shade base, for example a blue base, and twelve rectangular-shaped rooms 312 for receiving scanning objects formed therein. FIG. 2 is a schematic view of an image of the scanning object 314 received in one of the rectangular-shaped rooms 312. The scanning object 314 includes a strip code pattern 315, four test strips 316, 317, 318 and 319 each of which having a color pattern and four color charts 320, 321, 322 and 323. The strip code pattern 315 is disposed in a predetermined position of the scanning object 314, and four test strips 316, 317, 318 and 319, are arranged orderly in a column in the scanning object 314. The four color charts 320, 321, 322 and 323 are arranged orderly in a column beside the four test strip 316, 317, 318 and 319, and respectively corresponds to one of the four test strips 316, 317, 318 and 319. The four color charts 320, 321, 322 and 323 are used to discriminate the kinds of the four test strips 316, 317, 318 and 319. Each of the four test strips 316, 317, 318 and 319 has a color pattern having a control line (c) and at least one target line (T). The color pattern of each of the test strips 316, 317, 318 and 319 occurs due to contacting with a tested solution, such as a biological specimen, for example a urine specimen, collected from a subject. The control line (c) occurs in response to the tested solution, and the target line (T) occurs in response to a specific component of the tested solution. The test strips 316, 317, 318 and 319, respectively corresponding to one of the four charts 320, 321, 322 and 323, represents the test strips 316, 317, 318 and 319 are used to monitor respective specific components of the tested solution. Alternately, the test strips 316, 317, 318 and 319 belong to different design grades. In the present preferred embodiment, the test strips 316, 317, 318 and 319 can be various abuse-type drug test papers, and each of which can be designed to a different grade. For example, the abuse-type drug test papers can be classified to different grades for monitoring one specific component, two specific components, three specific components, four specific components, five specific components and six specific components etc. Referring again to FIG. 3B, the rectangular-shaped rooms 312 of the rectangular-shaped holder 31 can be designed to receive the scanning objects having different sizes. The scanning object can include a test strip, two test strips, three test strips, four test strips, five test strips or six test strips. The user can directly select a preview image of the scanning object 32 on the image preview window 30 to execute a normal scan. Alternately, the user can select several preview images of the scanning objects on the image preview window 30 at one time. The selection order of the preview images would be stored.

A first region for displaying image analysis results 33 is displayed on a left top portion of the user interface and used for displaying an image analysis result under a normal scan for at least the selected preview image. The display of the image analysis result includes a diagram 34 of image intensity versus image position of the target lines (T) of each of the test strips of the scanning object and a data table 35 of image intensity versus image position of the target lines (T). The data table 35 also displays an “ID” column for showing a set of codes corresponding to the strip code pattern of the scanning object and a “Name” column corresponding to a subject whose biological specimen is tested by the test strips of the scanning object. The user can key in the name of the subject in the “Name” column. In the data table 35, each of the test strips of the scanning object is given an item number in accordance with the sequence of the test strips arranged in the scanning object. The data table 35 also has a column “(Judgement/Control)” displaying responses of the target lines and control line of each of the test strips in response to the tested solution. “Judgement” displays the response of one of the target lines of the test strip and “Control” displays the response of the control line of the test strip. For example, both of the target line (T) and control line (c), for the second test strip of the scanning object represented by the item number “2”, have a positive response (+) in response to the tested solution. The control line (C) has a positive response (+), representing the amount of the tested solution is sufficient to pass through all the positions of the target lines of the test strip. Hence, only upon the situation of the control line (C) having a positive response (+), the specific components of the tested solution can be exactly and completely detected and identified depending upon the test strip. Under the situation of the control line (C) having a positive response (+), the target line has a positive response (+), representing a specific component to be detected is present in the tested solution. It is known that the image intensity of the target line of the test strip with the item number “2” is 117 from the data table 35. Besides, there are several selection buttons (Target 7, Target 8, Target 9, Target 10, Target 11, Target 12) displayed on a top portion of the first region for displaying image analysis results 33. The order of the selection buttons corresponds to the order of selection of the preview images on the image preview window 30. The user can click one of the selection buttons to switch the displaying of the first region for displaying image analysis results 33.

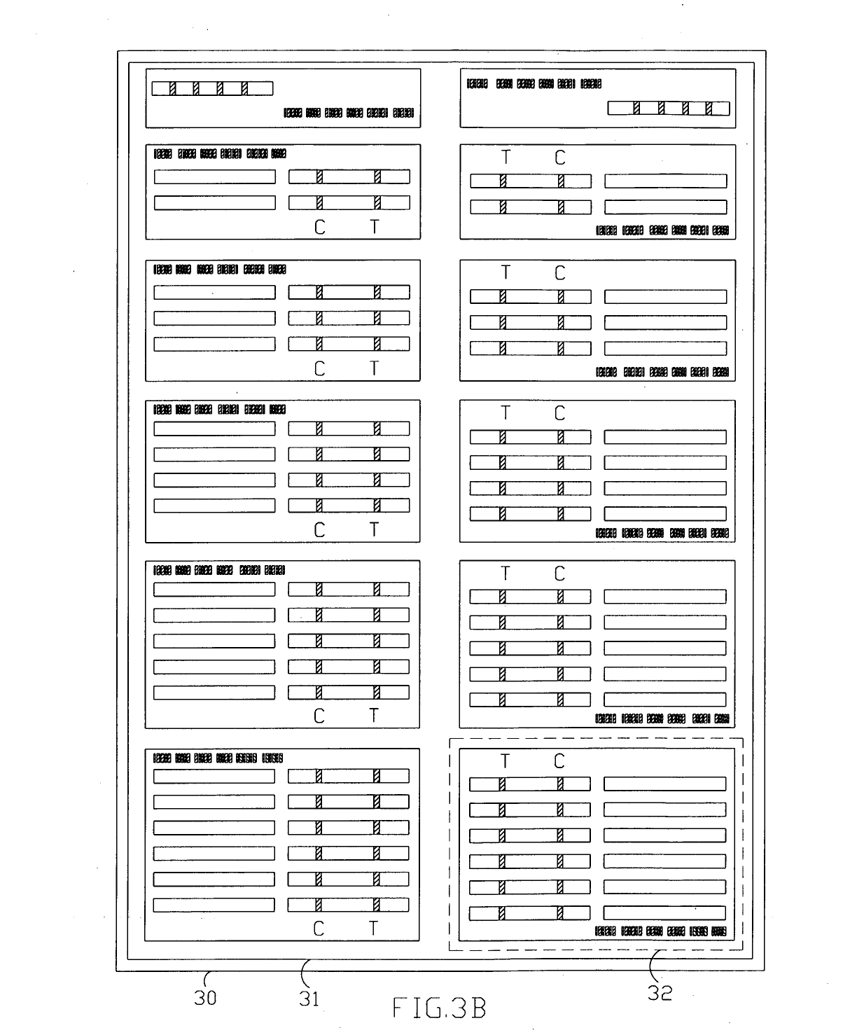

A second region for displaying function buttons 36 is displayed below the first region for displaying image analysis results 33 on the user interface. The function buttons includes a preview button (Preview), a scan button (Scan), an auto button (Auto), a print result button (Print Result), a print report button (Print Report) and an auto print button (Auto Print). The preview button provides an image preview scan function and the scan button provides a normal scan function for at least one selected preview image. The auto button provides a normal scan function for the whole page of preview images displayed on the preview window 30. The print result button provides a function for printing out the image analysis result under the normal scan for the selected preview image. FIG. 4 shows the image analysis results under the normal scan for the three selected preview images, respectively corresponding to a scanning object, printed out by clicking the print result button. As shown in FIG. 4, the image analysis result of each of the scanning objects include a set of code numbers (ID) and the image intensity of the target lines of each of test strips of the scanning object.

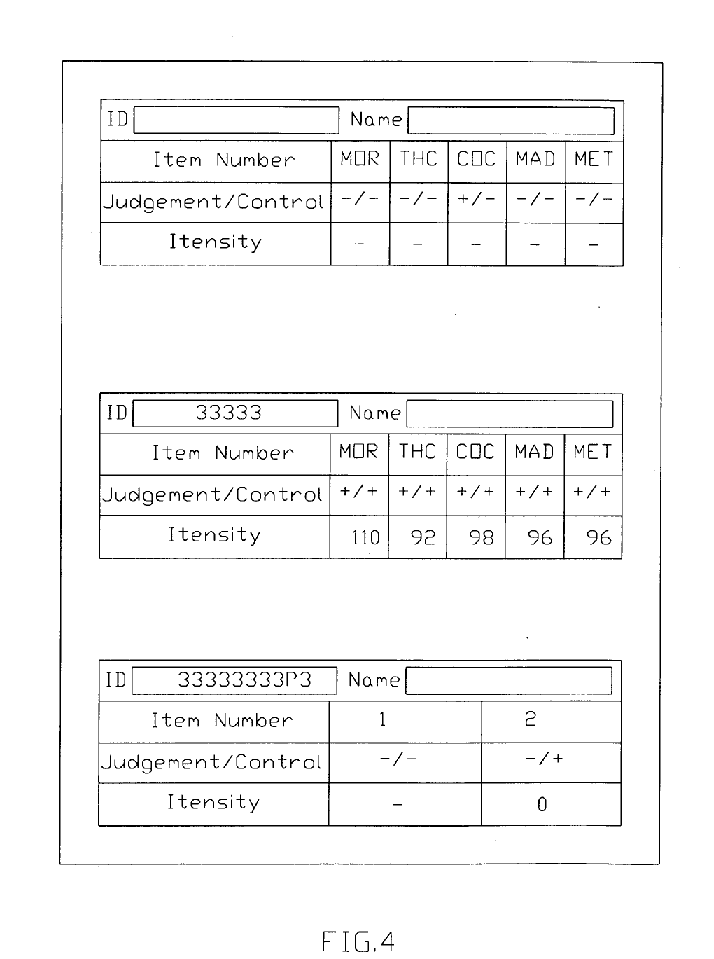

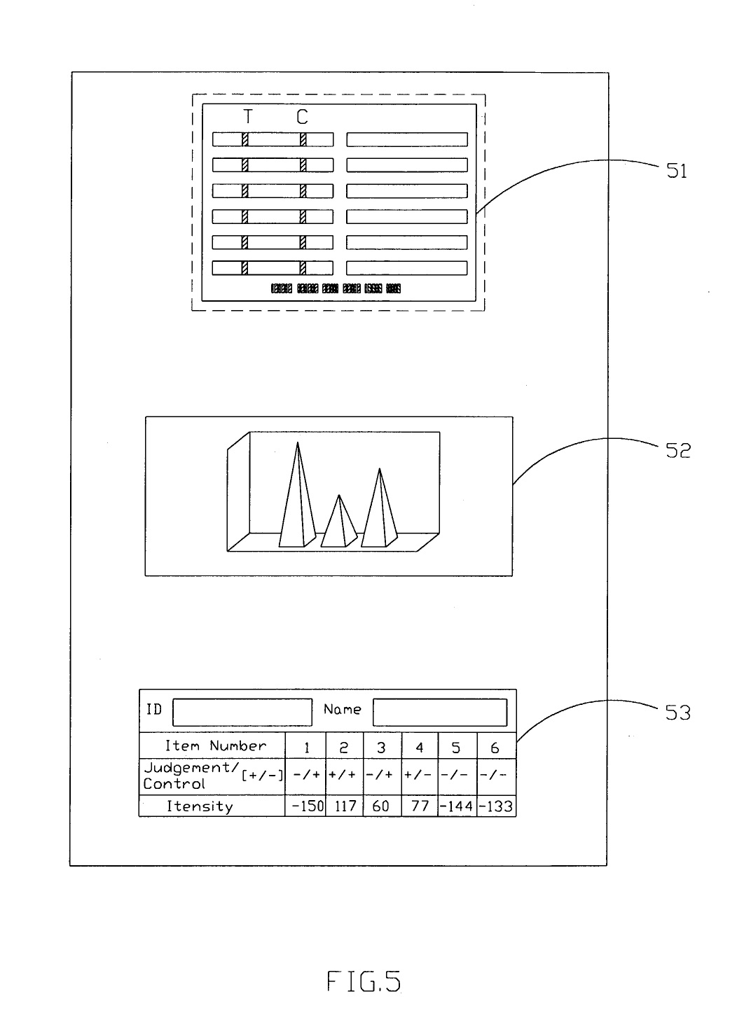

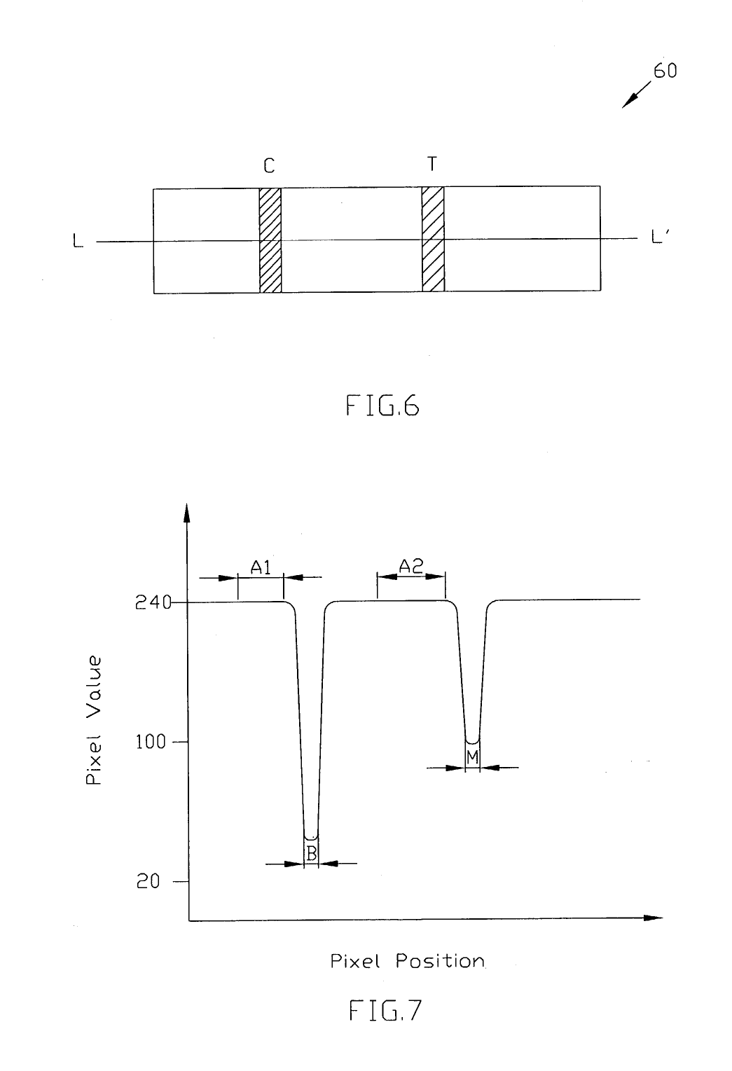

The target lines of each of the test strips can be given an item number, such as 1, 2, 3, 4, . . . etc., or directly named by a specific component to be detected. The print report button provides a function for printing out an image under the normal scan for the selected preview image and the image analysis result thereof. Referring to FIG. 5, the printing out by clicking the print report button includes an image 51 under the normal scan for the selected preview image, a diagram 52 of image intensity versus image positions of the target lines of the test strips of the scanning object and a data table 53 of the image intensity versus image positions of the target lines. The auto print button provides a function for print out images under the normal scan for the whole page of preview images displayed on the image preview window 30 and the image analysis results thereof.

The image capturing apparatus associated with the user interface of the present invention, for example a scanner associated with the user interface of the present invention, can be used to capture an image of a test strip having a color pattern occurring due to a tested solution, then analyzing the image and displaying/printing out the image analysis result of the test strip. Specific components in the tested solution can be detected and identified in accordance with the image analysis result. Therefore, the image capturing apparatus associated with the user interface can be utilized in the detection of drug of abuse to capture an image of an abuse-type drug test paper contacting with a biological specimen collected from a subject to monitor whether drugs of abuse present in the biological specimen.

In another aspect of the present invention, the present invention provides a method for identifying image positions of a color pattern of a test strip. The holder 31 having at least one scanning object received in one of the rectangular-shaped rooms 312 is provided. The scanning object includes at least a test strip having a color pattern displayed thereon. The holder 31 is placed in an appropriate position of the image capturing apparatus, for example upon a scanning platform, to capture an image of the holder 31 and the scanning object received therein. Referring to FIG. 2, the image of the scanning object includes the image of at least one test strip having a color pattern. Since the holder 31 has a rectangular-shaped outer frame 310 with heavy shade base, the image of the holder 31 would have low gray levels, i.e. low pixel values. The scanning object has a light shade base, for example a white base, the image of the light shade base would have high gray levels, i.e. high pixel values. The image of the boundary between the holder 31 (or the rectangular-shaped room 312) and the scanning object would show an abrupt change of gray levels, i.e. a large difference of pixel values. The image position of the color pattern of one of the test strips of the scanning object thus can be identified based on the abrupt change of gray levels of the image of the boundary between the holder 31 (or rectangular-shaped room 312) and the scanning object. The steps for identifying image positions of the color pattern of the test strip from the captured image are described as follows. Selecting an X-axis image position having a difference between its pixel value and a neighboring pixel value not less than a predetermined value to correspond to an X-axis boundary between the holder 31 and the scanning object from an X-axis direction of the captured image. Selecting a Y-axis image position having a difference between its pixel value and a neighboring pixel value not less than a predetermined value to correspond to a Y-axis boundary between the holder 31 and the scanning object from a Y-axis direction of the captured image. Determining the image positions of the color pattern of the test strip in accordance with the X-axis image position corresponding to the X-axis boundary, the Y-axis image position corresponding to the Y-axis boundary, and an X-axis dimension and a Y-axis dimension of the scanning object.

In a still another aspect of the present invention, the present invention provides a method for analyzing image information of a color pattern of a test strip. Firstly, an image of a test strip having a light color base and a color pattern is provided. The color pattern includes a control line and at least a target line. Selecting at least one scan line from the image, the scan line is perpendicular to the image of the control line and the target line. A diagram of pixel value versus pixel position for the control line and the target line is established in accordance with the scan line. Determining a color response R of the target line from the diagram and in accordance with a formula (I):

R={(M−B)/(A−B)}×100% (I),

wherein M represents an average pixel value of a section of pixels corresponding to the image of the target line, B represents an average pixel value of a section of pixels corresponding to the image of the control line, and A represents an average pixel value of a plurality of pixels corresponding to the images of the light color base adjacent to the image of the control line and a plurality of pixels corresponding to the images of the light color base adjacent to the image of the target line. For example, A can be an average pixel value of a first section A1 of pixels corresponding to the images of the light color base adjacent to one side of the image of the control line and a second section A2 of pixels corresponding to the images of the light color base adjacent to one side of the image of the target line. When the average pixel value B of a section of pixels corresponding to the image of the control line (C) is less than a predetermined value, the control line (C) has a positive response in response to a tested solution, and representing the amount of the tested solution contacting with the test strip is sufficient to pass through all the positions of the target lines of the test strip. Then, following, determining a color response R of the target line of the test strip in accordance with the formula (I). When the color response R is not less than a predetermined value, the target line has a positive response in response to the tested solution, and a specific component to be detected is present in the tested solution. When the color response R is less than a predetermined value, the target line has a negative response in response to the tested solution, and the specific component to be detected is absent in the tested solution.

The embodiments are only used to illustrate the present invention, not intended to limit the scope thereof. Many modifications of the embodiments can be made without departing from the spirit of the present invention.

What is claimed is:

1. A user interface of an image capturing apparatus, comprising:
an image preview window for displaying at least one preview image and serving for a user to select at least said preview image to perform a normal scan;
a first region for displaying image analysis results, non-overlapped with said image preview window, and used for displaying an image analysis result under said normal scan for at least said selected preview image; and
a second region for displaying function buttons, non-overlapped with said image preview window and said first region for displaying image analysis results.

2. The user interface of claim 1, wherein said image analysis result under said normal scan for at least said selected preview image displayed on said first region includes a diagram of image intensity versus image position and a data table listing image intensity versus image position.

3. The user interface of claim 2, wherein said first region for displaying image analysis results further includes a plurality of selection buttons for a user to switch displaying of said image analysis results under said normal scan for said selected preview images.

4. The user interface of claim 1, wherein said second region for displaying function buttons includes at least one function button selected from a group consisting of a preview button, a scan button, an auto button, a print result button, a print report button and an auto print button, wherein said preview button provides an image preview scan function, said scan button provides a normal scan function for at least said selected preview image, said auto button provides a normal scan function for the whole page of preview images displayed on said preview window, said print result button provides a function for printing out said image analysis result under said normal scan for at least said selected preview image, said print report button provides a function for printing out an image under said normal scan for at least said selected preview image and said image analysis result thereof, and said auto print button provides a function for print out images under said normal scan for the whole page of preview images displayed on said preview window and the image analysis results thereof.

5. The user interface of claim 4, wherein the output of said image analysis result under said normal scan for at least said selected preview image provided by said print result button includes a data table of image intensity versus image position.

6. The user interface of claim 4, wherein the output provided by said print report button includes an image under said normal scan for at least said selected preview image and a diagram of image intensity versus image position thereof and a data table of image intensity versus image position thereof.

7. The user interface of claim 4, wherein the output provided by said auto print button includes the images of the whole page of preview images displayed in said preview window and respective diagrams of image intensity versus image position thereof and respective data tables of image intensity versus image position thereof.

8. The user interface of claim 1, wherein a scanning object of said image capturing apparatus includes a test strip having a color pattern.

9. The user interface of claim 8, wherein said color pattern includes a control line and at least a target line.

10. The user interface of claim 8, wherein said scanning object having a strip code pattern representing said scanning object.

11. The user interface of claim 9, wherein said image analysis result under said normal scan for at least said selected preview image displayed on said first region includes a diagram of image intensity versus image position of at least said target line of at least said test strip and a data table listing image intensity versus image position of at least said target line of at least said test strip.

12. The user interface of claim 10, wherein said image analysis result under said normal scan for at least said selected preview image displayed on said first region includes a diagram of image intensity versus image position of at least said target line of at least said test strip, a data table listing image intensity versus image position of at least said target line of at least said test strip and a number representing said strip code pattern.

13. A method for identifying image positions of a color pattern of a test strip, comprising:
providing a holder for positioning scanning objects, said holder including a rectangular-shaped outer frame and a plurality of rectangular-shaped rooms formed therein for receiving at least one said scanning object, said scanning object having a light color base and including at least a test strip having a color pattern displayed thereon;
placing said holder on a scanning platform of an image capturing apparatus to capture an image of said holder and said scanning object received therein, wherein said image of said scanning object includes at least said test strip having said color pattern;
identifying image positions of said color pattern of said test strip from the captured image, including:
selecting an X-axis image position having a difference between its pixel value and a neighboring pixel value not less than a predetermined value to correspond to an X-axis boundary between said holder and said scanning object from an X-axis direction of the captured image;
selecting a Y-axis image position having a difference between its pixel value and a neighboring pixel value not less than a predetermined value to correspond to a Y-axis boundary between said holder and said scanning object from a Y-axis direction of the captured image; and
determining the image positions of said color pattern of said test strip in accordance with said X-axis image position corresponding to said X-axis boundary, said Y-axis image position corresponding to said Y-axis boundary, and an X-axis dimension and a Y-axis dimension of said scanning object.

14. The method of claim 13, wherein said holder includes a blue-based outer frame.

15. The method of claim 13, wherein said color pattern of said test strip includes a control line and at least a target line.

16. A method for analyzing image information of a color pattern of a test strip, comprising:
providing an image of a test strip having a light color base and a color pattern, said color pattern including a control line and at least a target line;
selecting at least one scan line from said image, said scan line being perpendicular to the image of said control line and said target line, and establishing a diagram of pixel value versus pixel position for said control line and said target line in accordance with said scan line; and
determining a color response R of said target line from said diagram and in accordance with a formula (I):
R={(M−B)/(A−B)}×100% (I),
wherein M represents an average pixel value of a section of pixels corresponding to the image of said target line, B represents an average pixel value of a section of pixels corresponding to the image of said control line, and A represents an average pixel value of a plurality of pixels corresponding to the images of said light color base adjacent to the image of said control line and a plurality of pixels corresponding to the images of said light color base adjacent to the image of said target line.

17. The method of claim 16, wherein said control line of said color pattern occurs in response to a tested solution contacting with said test strip and said target line occurs in response to a specific component of said tested solution.

18. The method of claim 17, wherein said color response R of said target line is determined from said diagram and in accordance with said formula (I) once said average pixel value B of a section of pixels corresponding to the image of said control line less than a predetermined value.

19. The method of claim 17, wherein when said color response R is not less than a predetermined value, defining said target line has a positive response in response to said specific component, representing said specific component present in said tested solution.

20. The method of claim 16, wherein A is an average pixel value of a first section of pixels corresponding to the images of said light color base adjacent to one side of the image of said control line and a second section of pixels corresponding to the images of said light color base adjacent to one side of the image of said target line.
